(19) United States
(12) Patent Application Publication
(10) Pub. No.: US 2015/0057001 A1
(43) Pub. Date: Feb. 26, 2015

(54) ELECTRONIC DEVICE AND METHOD FOR MANAGING COMMUNICATION SIGNALS USING THE ELECTRONIC DEVICE

(71) Applicants: Hon Hai Precision Industry Co., Ltd., New Taipei (TW); Hong Fu Jin Precision Industry (WuHan) Co., Ltd., Wuhan (CN)

(72) Inventors: TONG-QI HUANG, Wuhan (CN); JIAN-HUNG HUNG, New Taipei (TW)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 14/060,737

(22) Filed: Oct. 23, 2013

(30) Foreign Application Priority Data
Aug. 26, 2013 (CN) 2013103750823

(51) Int. Cl. H04W 36/00; H04W 88/02

(52) U.S. Cl. CPC H04W 36/0072; H04W 88/02
USPC 455/437; 455/566

(57) ABSTRACT

In a method for managing communication signals using an electronic device, a communications service provider of the electronic device is recognized according to an international mobile subscriber identity of the electronic device. Information of multiple neighboring base stations are obtained according to a frequency band of the communications service provider, and strength of the communication signals and addresses of the multiple neighboring base stations are obtained to display on a display device of the electronic device. One of the communication signals received from the multiple neighboring base stations is selected as a communication signal of the electronic device.

### BACKGROUND

1. Technical Field

The embodiments of the present disclosure relate to an electronic device and method for managing communication signals using the electronic device.

2. Description of Related Art

There may be multiple neighboring base stations in a certain region such as a community. A communication signal of an electronic device, such as a smart phone, may be switched back and forth among the multiple base stations, which is called “ping pong effect”, leading to poor phone call quality, and significantly increasing power consumption.

### BRIEF DESCRIPTION OF THE DRAWINGS

FIG. 1 is a block diagram of one embodiment of an electronic device including a communication signal management system.

FIG. 2 is a block diagram of one embodiment of function modules of the communication signal management system in FIG. 1.

FIG. 3 is a flowchart of one embodiment of a method for managing communication signals on the electronic device of FIG. 1.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module,” as used herein, refers to logic embodied in hardware or firmware, or to a collection of software instructions, written in a programming language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, flash memory, and hard disk drives.

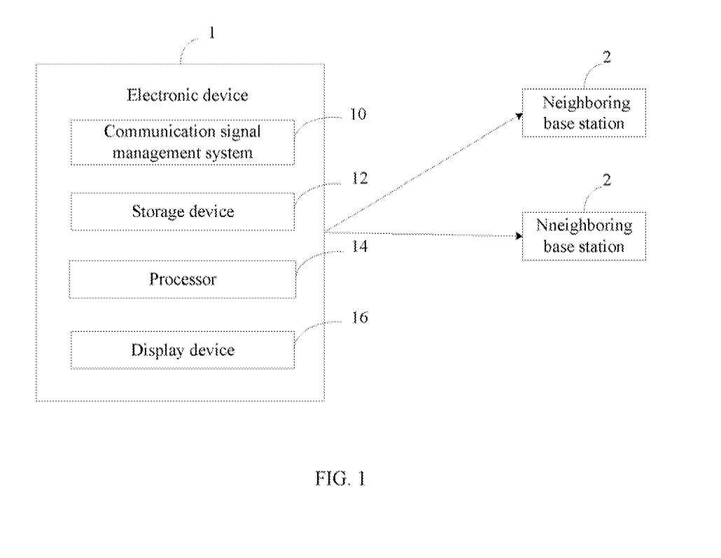

FIG. 1 is a block diagram of one embodiment of an electronic device 1 including a communication signal management system 10. The electronic device 1 comprises a storage device 12, at least one processor 14, and a display device 16. In the embodiment, the electronic device 1 may be a phone, a tablet computer, or a personal digital assistant (PDA), for example. The electronic device 1 communicates with multiple neighboring base stations 2 through a wireless network, such as WIFI or BLUETOOTH.

The neighboring base station 2 is a wireless communication station positioned at a fixed location and used to communicate as part of one of the following: using a push-to-talk two-way radio system, or a wireless telephone system such as cellular CDMA or GSM cell site. The wireless telephones are circuit switched by means of: the communications paths are set up by dialing at the start of a call and the path remains in place until one of the callers hangs up, and wireless telephones communicate with other telephones usually over the public switched telephone network.

In one embodiment, the storage device 12 (non-transitory storage device) may be an internal storage system, such as a random access memory (RAM) for the temporary storage of information, and/or a read only memory (ROM) for the permanent storage of information. In some embodiments, the storage device 12 may be an external storage system, such as an external hard disk, a storage card, or a data storage medium.

The at least one processor 14 may include a processor unit, a microprocessor, an application-specific integrated circuit, and a field programmable gate array, for example.

The display device 16 displays a strength of a communication signal received from each of the multiple neighboring base stations 2, and displays an address of each of the multiple neighboring base stations 2 on the electronic device 1. For example, the address may be apple garden of Shenzhen of china.

In one embodiment, the communication signal management system 10 includes a plurality of function modules which include computerized codes or instructions that can be stored in the storage device 12 and executed by the at least one processor 14 to provide a method for managing communication signals using the electronic device 1.

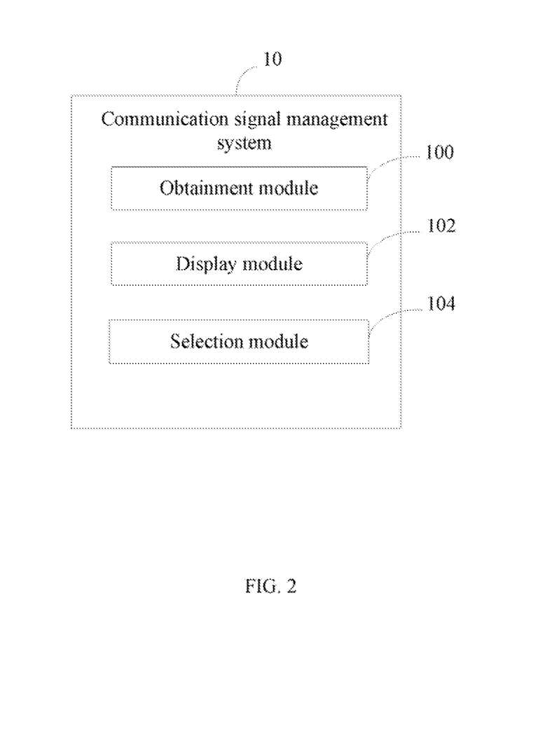

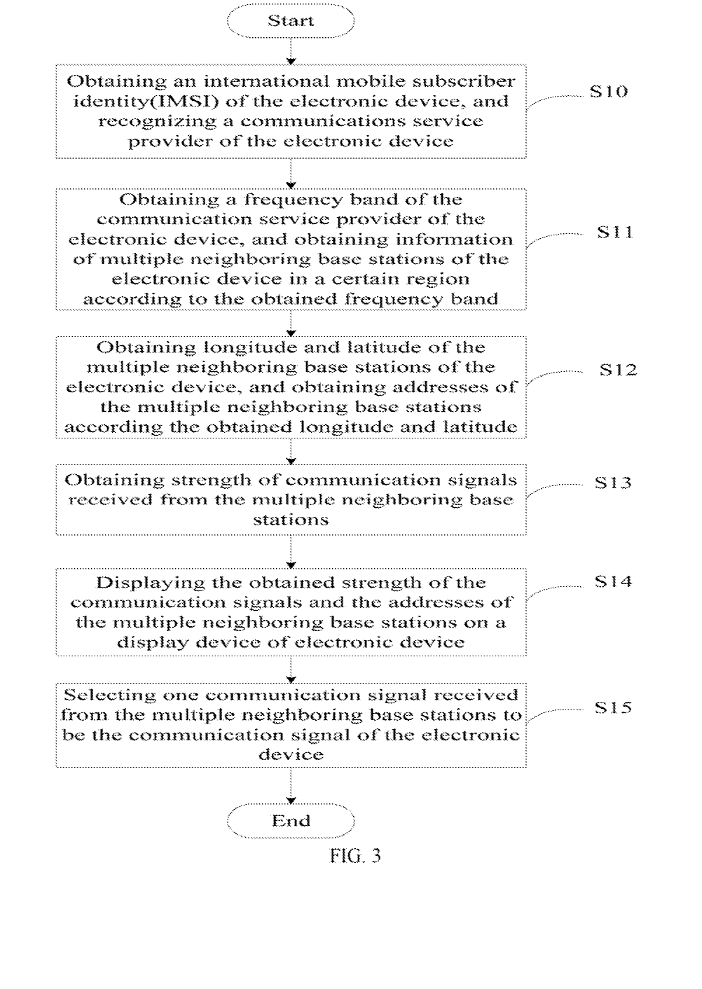

FIG. 2 is a block diagram illustrating function modules of the communication signal management system 10 included in the electronic device 1. In one embodiment, the communication signal selection system 10 may include an obtainment module 100, a display module 102, and a selection module 104. The modules may comprise computerized codes or instructions in the form of one or more programs that are stored in the storage device 12 and executed by the at least one processor 14 to provide functions for implementing the communication signal management system 10. The functions of the function modules are illustrated in FIG. 3 and described below.

FIG. 3 illustrates a flowchart of one embodiment of a method for managing communication signals using the electronic device 1 of FIG. 1. Depending on the embodiment, additional steps may be added, others removed, and the ordering of the steps may be changed.

In step S10, the obtainment module 100 obtains an international mobile subscriber identity (IMSI) of the electronic device 1, and further recognizes a communication service provider of the electronic device 1 according to the IMSI of the electronic device 1. In the embodiment, the operation system of communication device 1 may be an Android system. The obtainment module 100 obtains a predefined class (e.g., the class named TelephonyManager) of the Android system through an application programming interface (e.g., the class named Android API), and obtains IMSI through the sub class SubscriberId of the class TelephonyManager. The IMSI is used to identify a user of a cellular network and is a unique identification associated with all cellular networks. The IMSI is stored as a 64 bits field and is sent by the electronic device 1 to the wireless network. From example, the IMSI of the electronic device 1 may be an identification code represented by “4600013511078690,” wherein the code “460” is a mobile country code (MCC) indicating CHINA, the code “00” is a mobile network code (MNC) indicating CMCC, and the code “13511078690” is a mobile subscription identification number (MSIN) within the network's customer base.

In step S11, the obtainment 100 obtains a frequency band of the communication service provider of the electronic device 1, and obtains information of the multiple neighboring base stations 2 of the communication device 1 in a certain region such as a community, according to the obtained frequency band. In the embodiment, the information of each of the multiple neighboring base stations 2 may be a location area code, or a cell identity code which only identifies or recognizes the neighboring station 2.

In step S12, the obtainment module 100 obtains longitude and latitude of the multiple neighboring base stations 2 of the electronic device 1 according to the information of the multiple neighboring base stations 2, and further obtains addresses of the multiple neighboring base stations 2 according to the longitude and latitude of the multiple neighboring base stations 2.

In step S13, the obtainment 100 obtains and displays the strength of communication signals received from the multiple neighboring base stations 2 on the electronic device 1. In the embodiment, the obtainment 100 obtains the strength of communication signals received from the multiple neighboring base stations 2 from the class TelephonyManage.

In step S14, the displaying module 102 displays the strength of the communication signals received from the multiple neighboring base stations 2, and further displays the addresses of the multiple neighboring base stations 2 on the display device 16 of electronic device 1. In the embodiment, the displaying module 102 may further displays the ISMI of the electronic device 1 on the display device 16.

In step S15, the selection module 104 selects one of the communication signals received from the multiple neighboring base stations 2 as the communication signal of the electronic device 1 according to a need of the user of the electronic device 1. For example, the strongest communication signal may be selected to be the communication signal of the electronic device 1 if the user want to get a perfect online experience.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device, comprising:
at least one processor; and
a storage device storing a computer program including instructions that, which executed by the at least one processor, causes the at least one processor to:
obtain an international mobile subscriber identity (IMSI) of the electronic device, and recognize a communications service provider of the electronic device according to the IMSI;
obtain a frequency band of the communication service provider, and obtain information of multiple neighboring base stations of the electronic device in a certain region according to the obtained frequency band;
obtain longitude and latitude of the obtained multiple neighboring base stations according to the information of the multiple neighboring base stations, and obtain addresses of the multiple neighboring base stations according to the longitude and latitude of the multiple neighboring base stations;
obtain strength of communication signals received from the multiple neighboring base stations;
display the obtained strength of the communication signals and the addresses of the multiple neighboring base stations on a display device of the electronic device; and
select one of the communication signals received from the multiple neighboring base stations as a communication signal of the electronic device.

2. The electronic device according to claim 1, wherein the information of each of the neighboring base stations is a location area code or a cell identity code which only identifies the neighboring station.

3. The electronic device according to claim 1, wherein the IMSI of the electronic device is further displayed on the display device of the electronic device.

4. A method for managing communication signals using an electronic device, the method comprising:
obtaining an international mobile subscriber identity (IMSI) of the electronic device, and recognizing a communications service provider of the electronic device according to the IMSI of the electronic device;
obtaining a frequency band of the communication service provider of the electronic device, and obtaining information of multiple neighboring base stations of the electronic device in a certain region according to the obtained frequency band;
obtaining longitude and latitude of the multiple neighboring base stations of the electronic device according to the information of the multiple neighboring base stations, and obtaining addresses of the multiple neighboring base stations according to the longitude and latitude of the multiple neighboring base stations;
obtaining the strength of communication signals received from the multiple neighboring base stations;
displaying the obtained strength of communication signals and the addresses of the multiple neighboring base stations on a display device of the electronic device; and
selecting one of the communication signals received from the multiple neighboring base stations as a communication signal of the electronic device.

5. The method according to claim 4, wherein the information of each of the neighboring base stations is a location area code or a cell identity code which only identifies the neighboring station.

6. The method according to claim 4, wherein the IMSI of the electronic device is further displayed on the display device of the electronic device.

7. A non-transitory computer-readable storage medium having stored thereon instructions being executed by a processor of an electronic device, causes the processor to perform a method for managing communication signals using the electronic device, the method comprising:
obtaining an international mobile subscriber identity (IMSI) of the electronic device, and recognizing a communications service provider of the electronic device according to the IMSI of the electronic device;
obtaining a frequency band of the communication service provider of the electronic device, and obtaining information of multiple neighboring base stations of the electronic device in a certain region according to the obtained frequency band;
obtaining longitude and latitude of the multiple neighboring base stations of the electronic device according to the information of the multiple neighboring base stations, and obtaining addresses of the multiple neighboring base stations according to the longitude and latitude of the multiple neighboring base stations;
obtaining the strength of communication signals received from the multiple neighboring base stations;
displaying the obtained strength of the communication signals and the addresses of the multiple neighboring base stations on a display device of the electronic device; and
selecting one of the communication signals received from the multiple neighboring base stations as a communication signal of the electronic device.

8. The storage medium according to claim 7, wherein the information of each of the neighboring base stations is a location area code or a cell identity code which only identifies the neighboring station.

9. The storage medium according to claim 7, wherein the IMSI of the electronic device is further displayed on the display device of the electronic device.
